(19) United States
(12) Patent Application Publication
(10) Pub. No.: US 2008/0206639 A1
(43) Pub. Date: Aug. 28, 2008

(54) ACTIVE MATERIAL PARTICLE FOR ELECTRODE, ELECTRODE, ELECTROCHEMICAL DEVICE, AND PRODUCTION METHOD OF ELECTRODE

(75) Inventor: Masato KURIHARA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/033,414

(22) Filed: Feb. 19, 2008

(30) Foreign Application Priority Data
Feb. 23, 2007 (JP) 2007-044282
Jan. 23, 2008 (JP) 2008-012992

(51) Int. Cl. H01M 4/02; H01M 4/04

(52) U.S. Cl. 429/209

(57) ABSTRACT

An active material particle for electrode includes an active material body 4, and a conductive aid 6 with electron conductivity partially covering a surface of the active material body 4, a projection 8 comprised of the conductive aid 6 is formed on the surface of the active material body 4, and a height of the projection 8 from the surface of the active material body 4 is not less than 5% nor more than 30% of a particle size of the active material body 4.

### BACKGROUND OF THE INVENTION

1. Field of the Invention

The present invention relates to an active material particle for electrode, an electrode, an electrochemical device, and a production method of electrode.

2. Related Background Art

Recent development is outstanding in portable devices and the major driving force thereof is development of high-energy batteries including lithium-ion secondary batteries commonly used as a power supply for these devices. Such a high-energy battery is composed mainly of a cathode, an anode, and an electrolyte layer (e.g., a layer of a liquid electrolyte or solid electrolyte) disposed between the cathode and the anode.

A variety of research and development has been conducted on electrochemical devices such as the high-energy batteries including the lithium-ion secondary batteries and electrochemical capacitors including electric double-layer capacitors, toward further improvement in characteristics so as to adapt for future development of equipment loaded with the electrochemical devices, e.g., the portable devices. Particularly, there are desires for achievement of an electrochemical device with high output/input characteristics.

In the conventional batteries, the cathode and/or anode has a structure in which an active material-containing layer containing an active material for each electrode, a binder (synthetic resin or the like), a conductive aid, etc. is formed on a surface of a current collector (metal foil or the like).

However, electric contact was not sufficient between the electrode active material and the conductive aid in the conventional electrodes, and thus the fabricated electrodes had large resistance between active material particles or between the current collector and the active material particles, resulting in failure in achieving high output/input characteristics. For remedying this problem, there are constituent materials of electrodes suggested, e.g., cathode active materials obtained by defining the relationship between the active material and the conductive aid (their ratio, arrangement, etc.) (e.g., cf. Japanese Patent Applications Laid-open No. 2005-174586 and Laid-open No. 2004-14519).

### SUMMARY OF THE INVENTION

However, even if the electrodes were made using the cathode active materials described in the above-mentioned Applications Laid-open No. 2005-174586 and Laid-open No. 2004-14519, it was difficult to achieve fully satisfactory characteristics in terms of rapid charge-discharge performance of the electrochemical device.

The present invention has been accomplished in view of the problem of the conventional technology and an object of the invention is to provide an active material particle for electrode in an electrochemical device, which enables achievement of an electrochemical device with excellent rapid charge-discharge performance, and an electrode and an electrochemical device using it.

In order to achieve the above object, the present invention provides an active material particle for electrode, comprising an active material body, and a conductive aid with electron conductivity partially covering a surface of the active material body, wherein a projection comprised of the conductive aid is formed on the surface of the active material body and wherein a height of the projection from the surface of the active material body is not less than 5% nor more than 30% of a particle size of the active material body.

There was the conventional technology of defining the coverage of the conductive aid over the surface of the active material body, as described in the foregoing Application Laid-open No. 2004-14519, but this technology is to uniformly cover the surface of the active material body with the conductive aid. With active material particles obtained by this technology, electrical connection was insufficient between particles of the conductive aid with electron conductivity. For this reason, when an electrode was made using such active material particles, the active material particles failed to construct an effective conductive network together, so as to increase the internal resistance, and it was difficult to achieve fully satisfactory rapid charge-discharge performance of the electrochemical device.

In contrast to it, the active material particle of the present invention has the projection with the foregoing height comprised of the conductive aid on the surface of the active material body and, when an electrode is made using it, a probability of electric contact of the projection of one active material particle with the surface or the projection of the other active material particle becomes higher among active material particles than in the case without the projection, and the active material particles can construct an effective conductive network together. Therefore, when such active material particles are used to form an electrode and an electrochemical device, the electroconductivity inside the electrode is drastically enhanced, so as to reduce the internal resistance sufficiently, thereby enhancing the rapid charge-discharge performance of the electrochemical device.

In the present invention, the projection comprised of the conductive aid is a projection made of the conductive aid aggregating locally on the surface of the active material body. In a case where the covering part comprised of the conductive aid to cover the surface of the active material body is formed in a layer form, the projection refers to a portion projecting from the surface of the covering part of the layer form. The presence/absence of this projection can be confirmed by an SEM photograph of the active material particle.

In the active material particle for electrode according to the present invention, preferably, the conductive aid directly covers the active material body. This improves the electric contact between the active material body and the conductive aid.

In the active material particle for electrode according to the present invention, preferably, the projection has a region with a porosity larger on the tip side than on the active material body side. The sentence “the projection has a region with a porosity larger than that of the active material body, on the tip side thereof” means that a space occupancy of the conductive aid (an amount of the conductive aid per unit volume) is smaller on the tip side of the projection. When the projection has the region with the larger porosity on the tip side and when the tip of the projection comes into contact with another active material particle or conductive aid, the shape of the projection tip becomes more likely to deform in accordance with the shape of the other active material particle or conductive aid, which is advantageous in terms of adhesion between active material particles. For this reason, the active material particles can construct a more effective conductive network together.

The present invention also provides an electrode comprising as a constituent material an active material particle for electrode comprising an active material body, and a conductive aid with electron conductivity partially covering a surface of the active material body, wherein a projection comprised of the conductive aid is formed on the surface of the active material body and wherein a height of the projection from the surface of the active material body is not less than 5% nor more than 30% of a particle size of the active material body.

Since this electrode comprises the active material particle for electrode of the present invention with the aforementioned effect as the constituent material, the internal resistance is adequately reduced. When it is used as an electrode of an electrochemical device, its rapid charge-discharge performance is extremely excellent.

The present invention further provides an electrochemical device comprising an anode, a cathode, and an electrolyte layer with ion conductivity, and having a structure in which the anode and the cathode are opposed to each other through the electrolyte layer, wherein at least one of the anode and the cathode is an electrode comprising as a constituent material an active material particle for electrode comprising an active material body, and a conductive aid with electron conductivity partially covering a surface of the active material body, wherein a projection comprised of the conductive aid is formed on the surface of the active material body and wherein a height of the projection from the surface of the active material body is not less than 5% nor more than 30% of a particle size of the active material body.

Since the electrochemical device uses the electrode of the present invention with the aforementioned effect as the anode and/or the cathode, it has excellent rapid charge-discharge performance. In the present specification, the “anode” is based on the polarity of the electrochemical device during discharging (negative electrode), and the “cathode” is based on the polarity of the electrochemical device during discharging (positive electrode).

The present invention further provides a production method of an electrode comprising a step of mixing a binder and a conductive aid with an active material particle for electrode comprising an active material body, and a conductive aid with electron conductivity partially covering a surface of the active material body, wherein a projection comprised of the conductive aid is formed on the surface of the active material body and wherein a height of the projection from the surface of the active material body is not less than 5% nor more than 30% of a particle size of the active material body.

The present invention successfully provides the active material particle for electrode in the electrochemical device, which enables achievement of the electrochemical device with excellent rapid charge-discharge performance, and the electrode and the electrochemical device using it.

### BRIEF DESCRIPTION OF THE DRAWINGS

FIG. 1 is a schematic sectional view showing the major part of an active material particle according to the present invention.

FIG. 2 is a schematic sectional view showing the major part of an active material particle according to the present invention.

FIG. 3 is a schematic sectional view showing a preferred embodiment of the electrode according to the present invention.

FIG. 4 is a front view showing a preferred embodiment of the electrochemical device according to the present invention.

FIG. 5 is a development view in which the interior of the electrochemical device shown in FIG. 4 is viewed from a direction of a normal to the surface of anode 10.

FIG. 6 is a schematic sectional view obtained by cutting the electrochemical device shown in FIG. 4, along line X1-X1 in FIG. 4.

FIG. 7 is a schematic sectional view of the major part obtained by cutting the electrochemical device shown in FIG. 4, along line X2-X2 in FIG. 4.

FIG. 8 is a schematic sectional view of the major part obtained by cutting the electrochemical device shown in FIG. 4, along line Y-Y in FIG. 4.

FIG. 9 is a schematic sectional view showing an example of a basic structure of a film as a constituent material of a case of the electrochemical device shown in FIG. 4.

FIG. 10 is a schematic sectional view showing another example of the basic structure of the film as a constituent material of the case of the electrochemical device shown in FIG. 4.

FIG. 11 is an SEM photograph (at the magnification of ×30000) of active material particles in Example 1.

FIG. 12 is an SEM photograph (at the magnification of ×30000) of an active material body and a conductive aid in a conventional electrode.

FIG. 13 is an enlarged photograph of a part of the SEM photograph of active material particles in Example 1 shown in FIG. 11.

FIG. 14 includes (A) to (C) as schematic views showing a microelectrode measuring system.

FIG. 15 is a graph showing a relation between charge/discharge rate and time during constant-potential charge/discharge of the active material particle obtained in Example 1.

### DESCRIPTION OF THE PREFERRED EMBODIMENTS

The preferred embodiments of the present invention will be described below in detail, while referring to the drawings as occasion demands. Identical or equivalent portions will be denoted by the same reference symbols in the drawings, without redundant description. It is also noted that the dimensional ratios in the drawings are not limited to those illustrated.

(Active Material Particle)

The active material particle of the present invention is one containing an active material body, and a conductive aid with electron conductivity partially covering a surface of the active material body, in which a projection comprised of the conductive aid is formed on the surface of the active material body and in which a height of the projection from the surface of the active material body is not less than 5% nor more than 30% of a particle size of the active material body.

The presence/absence of the projection can be confirmed by an SEM (Scanning Electron Microscope) photograph of the active material particle. It is determined in the present invention that “the projection is present” if the SEM photograph of the active material particle is taken at the magnification of ×30000 at each of ten random portions and if there is one or more projections per photograph at each portion (one photograph) on average. It is noted that a fine powder of the active material body may be mixed in the projection.

This projection needs to have the height from the surface of the active material body being not less than 5% nor more than 30% of the particle size of the active material body, from the viewpoint of sufficiently increasing the probability of electric contact between a plurality of active material particles. More specifically, where A represents the height of the projection and D (in the same unit as A) represents the particle size of the active material body on which the projection is formed, R (%) is defined as a ratio of the height of the projection to the particle size of the active material body represented by the following equation:

R=(A/D)×100;

the value of ratio R is determined for all the projections observed in the SEM photographs of the aforementioned ten random portions; a maximum Rₘₐₓ (%) thereof needs to be not less than 5% nor more than 30%. If the value of this Rₘₐₓ is less than 5%, formation of effective paths tends to become less likely because of the low projections in construction of electron-conductive paths among a large number of active material particles as an electrode; if the value exceeds 30%, the resistance tends to become larger because of the too high projections in construction of electron-conductive paths among a large number of active material particles as an electrode. From the same viewpoint, the maximum Rₘₐₓ of the ratio of the height of the projection to the particle size of the active material body is more preferably not less than 6% nor more than 28% and particularly preferably not less than 7% nor more than 13%. The particle size of the active material body means a minor-axis diameter obtained by SEM. From the viewpoint of constructing more effective electron-conductive paths among a large number of active material particles, there are preferably five or more projections with the foregoing value of R being not less than 5 nor more than 30% and more preferably ten or more projections with the value of R being not less than 5 nor more than 30%, among all the projections observed in the SEM photographs of the aforementioned ten random portions.

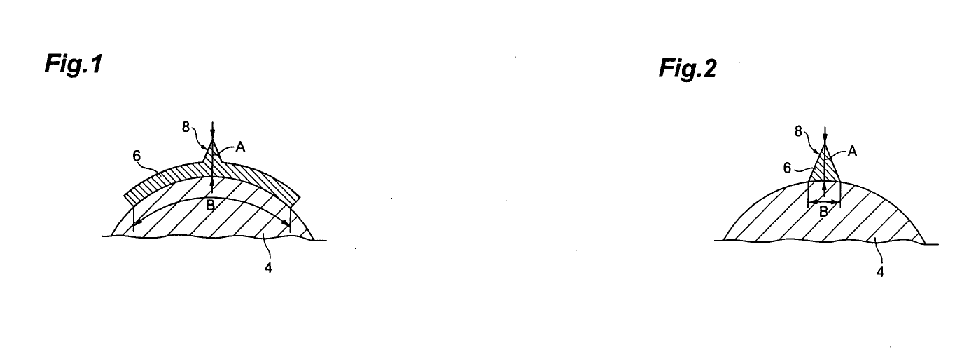

FIGS. 1 and 2 are schematic sectional views showing the major part of active material particles according to the present invention. In the active material particles shown in FIGS. 1 and 2, the conductive aid 6 partially covers the surface of the active material body 4 and the projection 8 comprised of the conductive aid 6 is formed on the surface of the active material body 4. In the active material particle of FIG. 1, a covering part of the conductive aid 6 is formed in a layer form and the projection 8 is formed as projecting from the surface of the covering part.

The shape of the projection in the active material particle of the present invention is preferably such a shape that a ratio (A/B) of the height A of the projection 8 to a length B of a side (base) of the entire covering part in contact with the active material body 4 in FIGS. 1 and 2, is not less than 1/30 nor more than 30 and more preferably such a shape that the ratio (A/B) is not less than 1/10 nor more than 5. Concerning this ratio (A/B), the value thereof is determined for all the projections observed in the aforementioned SEM photographs of the ten random portions and a maximum thereof preferably falls in the aforementioned range. If the height A of the projection 8 is larger over the above ratio, the projection 8 is too long and the resistance tends to increase in construction of electron-conductive paths among a large number of active material particles as an electrode. On the other hand, if the length B of the base is larger over the above ratio, the projection 8 is too small and formation of effective paths tends to become less likely in construction of electron-conductive paths among a large number of active material particles as an electrode.

The active material particle of the present invention preferably has a continuous layer comprised of the conductive aid covering not less than 10 nor more than 80% of the surface of the active material body. The percentage of this continuous layer is determined by the following specific method. Namely, the SEM photograph of the active material particle is taken at the magnification of ×30000 at each of ten random portions and a grid pattern of 1 μm×1 μm is drawn on each photograph at one portion (one photograph). In this 1 μm×1 μm field, a rate of an area of the largest continuously-extending conductive aid is calculated to a total area of the active material body and the conductive aid adhering thereto, and an average among a total of 120 fields is calculated as a percentage of the continuous layer of the conductive aid in the active material particle.

The percentage of the continuous layer is preferably not less than 10% nor more than 80%, more preferably not less than 15% nor more than 50%, and particularly preferably not less than 20% nor more than 45%. If the percentage of the continuous layer is smaller than the above range, an effective conductive network is less likely to be constructed in the electrode when an electrochemical device is formed, and the internal resistance tends to increase, so as to degrade the rapid charge-discharge performance, when compared with the case where the percentage of the continuous layer is within the above range. On the other hand, if the percentage of the continuous layer is larger than the above range, the area available for insertion, desorption, etc. of lithium ions tends to decrease when compared with the case where the percentage of the continuous layer is within the range, which is not preferred.

In the active material particle of the present invention, the coverage of the conductive aid over the active material body is preferably not less than 20% nor more than 90%, more preferably not less than 30% nor more than 80%, and particularly preferably not less than 40% nor more than 70%. If this coverage is less than 20%, when an electrochemical device is formed, the probability of electric contact between a plurality of active material particles in an electrode becomes lower and the internal resistance tends to increase, so as to degrade the rapid charge-discharge performance, when compared with the case where the coverage is within the above range. On the other hand, if the coverage exceeds 90%, the area available for desorption and insertion of lithium ions, desorption and adsorption of electrolyte ions, etc. decreases in the surface of the active material body and the rapid charge-discharge performance tends to degrade, when compared with the case where the coverage is within the above range.

The coverage of the conductive aid over the active material body is a percentage by which the conductive aid covers the active material body in the active material particle and is specifically determined by the following method. Namely, the SEM photograph of the active material particle is taken at the magnification of ×30000 at each of ten random portions and a grid pattern of 1 μm×1 μm is drawn on each photograph at one portion (one photograph). In this 1 μm×1 μm field, a percentage of an area of the conductive aid is determined to the total area of the active material body and the conductive aid adhering thereto, and an average among a total of 120 fields is calculated as a coverage in the active material particle.

In the active material particle for electrode of the present invention, not less than 5 nor more than 60% of the surface of the active material body is preferably exposed without being covered by the conductive aid, and is continuous. This continuous exposed part of the surface of the active material body will be referred to hereinafter as “continuously-exposed part.” When the active material particle has the continuously-exposed part, it makes desorption and insertion of lithium ions, desorption and adsorption of electrolyte ions, and so on more likely to occur. The percentage of this continuously-exposed part is preferably not less than 5% nor more than 60%, and it is more preferably not less than 10% nor more than 50% and particularly preferably not less than 20% nor more than 40% from the viewpoint of achieving the above effect better.

The percentage of the continuously-exposed part in the active material body herein is a percentage of the exposed part that is exposed without being covered by the conductive aid on the active material body and continuously extending, and is specifically determined by the following method. Namely, the SEM photograph of the active material particle is taken at the magnification of ×30000 at each of ten random portions and a grid pattern of 1 μm×1 μm is drawn on each photograph at one portion (one photograph) In this 1 μm×1 μm field, a percentage of an area of the exposed part of the largest continuously-extending active material particle is determined to the total area of the active material body and the conductive aid adhering thereto, and an average among a total of 120 fields is calculated as a percentage of the continuously-exposed part.

The active material body used as a constituent material of the active material particle according to the present invention can be optionally selected according to the type of the electrochemical device and the polarity of the electrode to which it is applied, and can be one of the well-known electrode active materials in the electrochemical devices, without particular restrictions. When the active material particle is used as a constituent material of an anode in a secondary battery, the active material body can be, for example, one selected from carbon materials such as graphite, non-graphitizing carbon, graphitizing carbon, and low temperature-calcined carbon capable of occluding and releasing lithium ions (i.e., capable of being intercalated or doped with lithium ions, and being dedoped), metals such as Al, Si, and Sn capable of combining with lithium, amorphous compounds consisting mainly of oxides such as SiO₂ and SnO₂, lithium titanate (Li₄Ti₅O₁₂), and so on. When the active material particle is used as a constituent material of a cathode in a secondary battery, the active material body can be, for example, one selected from lithium cobaltate (LiCoO₂), lithium nickelate (LiNiO₂), lithium manganese spinel (LiMn₂O₄), and composite metal oxides represented by general formula: LiNiₓMn_{y}Co_{z}O₂ (x+y+z=1), lithium vanadium compounds, V₂O₅, olivine type LiMPO₄ (where M is Co, Ni, Mn, or Fe, or a composite metal thereof), lithium titanate (Li₄Ti₅O₁₂), and so on. When the active material particle is used as a constituent material of electrodes in an electrochemical capacitor, the active material body can be, for example, one selected from granular or fibrous activated carbons after activation treatment, metal oxides, and so on and is particularly preferably one selected from those with high electric double-layer capacitance such as coconut shell activated carbon, pitch-based activated carbon, and phenol resin activated carbon.

There are no particular restrictions on the average particle size of the active material body and the average particle size can be optionally selected according to the type of the electrochemical device and the polarity of the electrode to which it is applied. When the active material particle is used as a constituent material of an anode in a secondary battery, the average particle size of the active material body is preferably not less than 0.1 μm nor more than 50 μm and more preferably not less than 1 μm nor more than 30 μm. When the active material particle is used as a constituent material of a cathode in a secondary battery, the average particle size of the active material body is preferably not less than 0.1 μm nor more than 30 μm and more preferably not less than 1 μm nor more than 20 μm. When the active material particle is used as a constituent material of electrodes in an electrochemical capacitor, the average particle size of the active material body is preferably not less than 0.1 μm nor more than 50 μm and more preferably not less than 1 μm nor more than 30 μm. When the average particle size of the active material body is set in the foregoing range, the density of the active material is increased in the electrode and holes tend to have an appropriate shape.

There are no particular restrictions on the conductive aid used as a constituent material of the active material particle according to the present invention as long as it has electron conductivity. The conductive aid can be one of well-known conductive aids. Examples of such conductive aids include carbon materials such as carbon blacks, highly crystalline artificial graphite, and natural graphite, metal materials such as gold, platinum, copper, nickel, stainless steel, and iron, mixtures of the foregoing carbon materials and metal materials, conductive oxides such as ITO, and so on.

There are no particular restrictions on an average primary particle size of the conductive aid, but the average primary particle size is preferably not less than 0.01 μm nor more than 10 μm and more preferably not less than 0.02 μm nor more than 3 μm. When this average primary particle size is less than 0.01 μm, the conductive aid tends to fail to form an appropriate projection; if it exceeds 10 μm, the conductive aid tends to fail to properly cover the surface of the active material body.

In the active material particle of the present invention, a ratio of the average particle size of the active material body to the average primary particle size of the conductive aid (average particle size of active material body/average primary particle size of conductive aid) is preferably not less than 5 nor more than 5000 and more preferably not less than 10 nor more than 1000. If this particle size ratio is less than 5, the conductive aid tends to fail to properly cover the surface of the active material body; if it exceeds 5000, the conductive aid tends to fail to form an appropriate projection.

In the active material particle of the present invention, a ratio of contents of the active material body and the conductive aid is preferably in the range of 100:1 to 2:1 as a volume ratio and more preferably in the range of 60:1 to 5:1. When this ratio of contents is set in this range, it tends to become feasible to achieve appropriate covering over the surface of the active material body and formation of an appropriate projection.

The active material particle of the present invention may be one having at least the active material body and the conductive aid, and may further contain, for example, a binder, a solid electrolyte, etc. as other ingredients. From the viewpoint of achieving the effect of the present invention better, the active material particle of the present invention is preferably one consisting substantially of the active material body and the conductive aid only. When the active material particle contains a binder, the binder tends to be interposed between the active material body and the conductive aid to cause an increase in the internal resistance. In contrast to it, when in the active material particle the conductive aid is adhered directly to the active material body without use of the binder or the like, the internal resistance can be reduced more reliably and the rapid charge-discharge performance of the electrochemical device can be improved more definitely.

The active material particle of the present invention as described above can be produced, for example, by one of the following methods. Namely, the active material particle wherein the conductive aid partially covers the surface of the active material body can be produced by a method of dry-processing the active material body and the conductive aid with a ball mill and then thermally treating them in an inert atmosphere, a method of attaching the conductive aid (carbon or the like) to the active material body by chemical vapor deposition with a fluid bed reactor or the like, a method of mixing the active material body and precursor solutions of the conductive aid (carbon or the like) and then thermally treating the solution mixture in an inert atmosphere, or the like. It should be noted that the production methods of the active material particle are not limited to these methods.

For producing the active material particle, it is preferable to control the production conditions and others so as to obtain the active material particle satisfying the aforementioned conditions for the coverage and the percentage of the continuous layer. For example, when the active material body and the conductive aid are mechanically mixed by means of a ball mill or the like, the coverage tends to decrease with insufficient mixing, but excessive mixing tends to decrease the percentage of the continuous layer because of too uniform dispersion of the conductive aid; therefore, it is preferable to mix them under an optimal condition for achieving both of the coverage and the percentage of the continuous layer within the respective ranges defined in the present specification.

(Electrode)

The electrode of the present invention comprises the active material particle for electrode of the present invention as a constituent material. The electrode herein may be, for example, one having a structure in which an electrically-conducive active material-containing layer containing the active material particles for electrode is formed on an electrically-conductive current collector, or one consisting of only a composition containing the active material particles without a current collector.

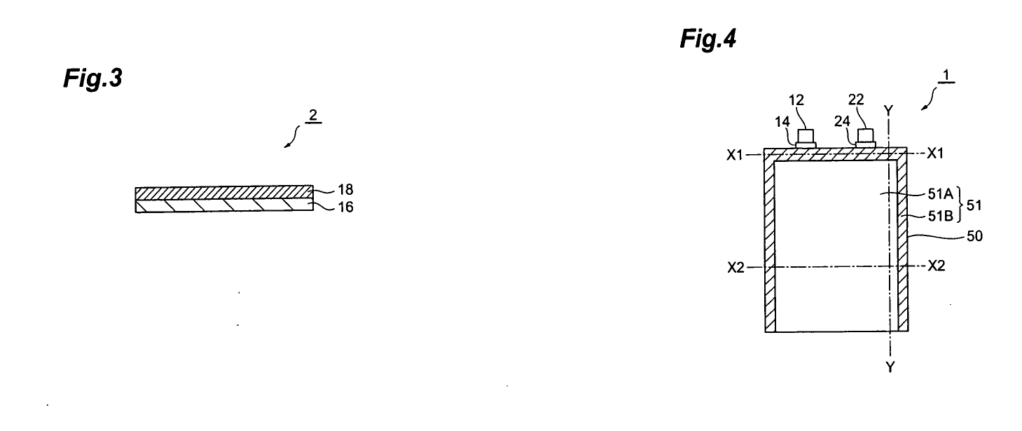

FIG. 3 is a schematic sectional view showing a preferred embodiment of the electrode of the present invention. The electrode 2, as shown in FIG. 3, is composed of a current collector 16, and an active material-containing layer 18 formed on the current collector 16.

There are no particular restrictions on the current collector 16 as long as it is a good conductor capable of implementing adequate movement of charge to the active material-containing layer 18. The current collector 16 can be one of the current collectors used in the well-known electrochemical devices. For example, the current collector 16 can be a metal foil of copper, aluminum, or the like.

The active material-containing layer 18 is composed mainly of the above-described active material particle of the present invention, and a binder. The active material-containing layer 18 may further contain a conductive aid.

Any one of the well-known binders can be used as the binder used in the active material-containing layer 18, without any particular restrictions, and examples thereof include fluorine resins such as polyvinylidene fluoride (PVDF), polytetrafluoroethylene (PTFE), a tetrafluoroethylene-hexafluoropropylene copolymer (FEP), a tetrafluoroethylene-perfluoroalkylvinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF). This binder binds the constituent materials, e.g., the active material particles and the conductive aid added if necessary, together and also contributes to binding between those constituent materials and the current collector.

Besides the above examples, the binder may be, for example, one of vinylidene fluoride-based fluororubbers such as vinylidene fluoride-hexafluoropropylene fluororubber (VDF-HFP fluororubber), vinylidene fluoride-hexafluoropropylene-tetrafluoroethylene fluororubber (VDF-HFP-TFE fluororubber), vinylidene fluoride-pentafluoropropylene fluororubber (VDF-PFP fluororubber), vinylidene fluoride-pentafluoropropylene-tetrafluoroethylene fluororubber (VDF-PFP-TFE fluororubber), vinylidene fluoride-perfluoromethylvinylether-tetrafluoroethylene fluororubber (VDF-PFMVE-TFE fluororubber), and vinylidene fluoride-chlorotrifluoroethylene fluororubber (VDF-CTFE fluororubber).

Furthermore, in addition to the above examples, the binder may also be, for example, one of polyethylene, polypropylene, polyethylene terephthalate, aromatic polyamide, cellulose, styrene-butadiene rubber, isoprene rubber, butadiene rubber, and ethylene-propylene rubber. The binder may also be one of thermoplastic elastomer polymers such as styrene-butadiene-styrene block copolymers and hydrogenated derivatives thereof, styrene-ethylene-butadiene-styrene copolymers, and styrene-isoprene-styrene block copolymers and hydrogenated derivatives thereof. Furthermore, the binder may be one of syndiotactic 1,2-polybutadiene, ethylene-vinyl acetate copolymers, and propylene-α-olefin (C2-C12 olefin) copolymers. In addition, it may be one of electrically-conductive polymers.

There are no particular restrictions on the conductive aid used, if necessary, in the active material-containing layer 18, and it can be the same as the conductive aid used as a constituent material in the active material particles.

The content of the active material particles in the active material-containing layer 18 is preferably not less than 80% by mass, based on the total solid content of the active material-containing layer 18, and more preferably not less than 90% by mass. If this content is less than 80% by mass, the density of the active material is so low that the energy density tends to decrease.

For producing the electrode 2, the aforementioned constituent components are first mixed and dispersed in a solvent in which the binder is soluble, to prepare a coating solution (slurry or paste or the like) for formation of the electrode. There are no particular restrictions on the solvent as long as the binder is soluble therein. The solvent applicable herein can be, for example, N-methyl-2-pyrrolidone or N,N-dimethylformamide.

Next, the coating solution for formation of the electrode is applied onto the surface of the current collector 16, and dried, and then the resultant is rolled to form the active material-containing layer 18 on the current collector 16, thereby completing production of the electrode 2. There are no particular restrictions on how to apply the coating solution for formation of the electrode onto the surface of the current collector 16, and an appropriate method may be determined according to the material and shape of the current collector 16, and the like. Methods of application applicable herein include, for example, metal mask printing, electrostatic coating, dip coating, spray coating, roll coating, the doctor blade method, gravure coating, and screen printing.

(Electrochemical Device)

The electrochemical device of the present invention is an electrochemical device comprising an anode, a cathode, and an electrolyte layer with ion conductivity, and having a structure in which the anode and the cathode are opposed to each other through the electrolyte layer, wherein at least one of the anode and the cathode is the electrode of the present invention.

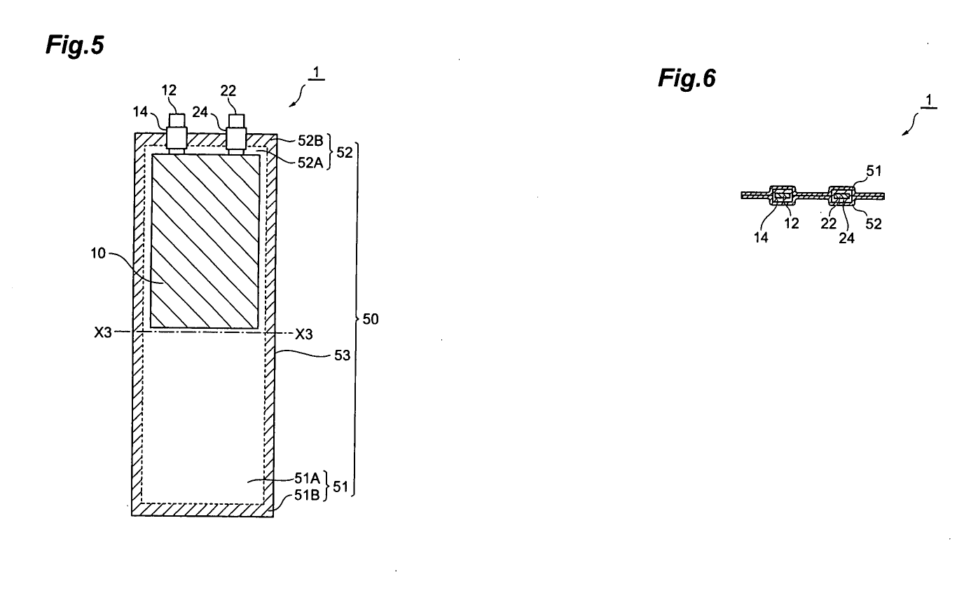

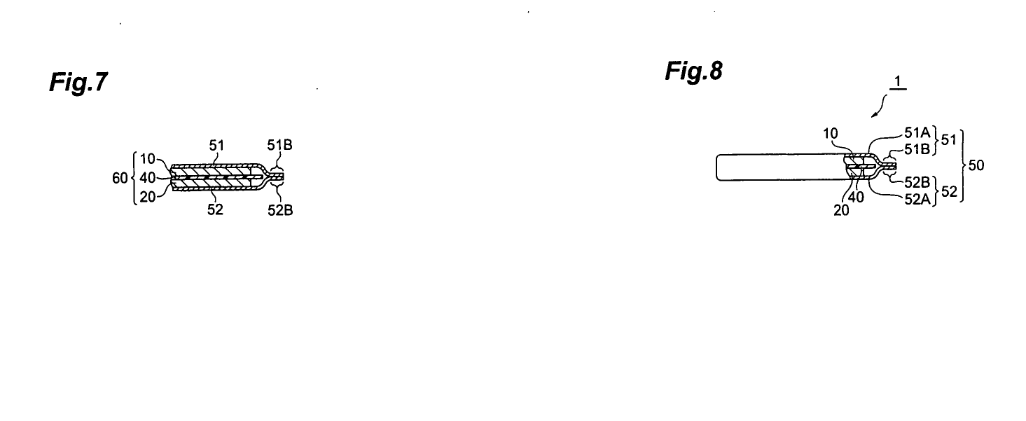

FIG. 4 is a front view showing a preferred embodiment of the electrochemical device of the present invention (lithium-ion secondary battery). FIG. 5 is a development view in which the interior of the electrochemical device shown in FIG. 4 is viewed from a direction of a normal to the surface of the anode 10. Furthermore, FIG. 6 is a schematic sectional view obtained by cutting the electrochemical device shown in FIG. 4, along line X1-X1 in FIG. 4. FIG. 7 is a schematic sectional view of the major part obtained by cutting the electrochemical device shown in FIG. 4, along line X2-X2 in FIG. 4. FIG. 8 is a schematic sectional view of the major part obtained by cutting the electrochemical device shown in FIG. 4, along line Y-Y in FIG. 4.

As shown in FIGS. 4 to 8, the electrochemical device 1 is composed mainly of a platelike anode 10 and a platelike cathode 20 facing each other, a platelike separator 40 arranged in proximity to and between the anode 10 and the cathode 20, an electrolyte solution (nonaqueous electrolyte solution in the present embodiment) containing lithium ions, a case 50 housing these in a hermetically closed state, an anode lead 12 one end of which is electrically connected to the anode 10 and the other end of which is projecting outward from the case 50, and a cathode lead 22 one end of which is electrically connected to the cathode 20 and the other end of which is projecting outward from the case 50.

In this structure at least one of the anode 10 and the cathode 20 is the aforementioned electrode 2 of the present invention. Since in the lithium-ion secondary battery the cathode generally tends to have low conductivity, the electrode 2 of the present invention is preferably used at least as the cathode 20. In cases where the electrode 2 of the present invention is not used as the anode 10 or as the cathode 20, the well-known anode 10 or cathode 20 can be used without any particular restrictions.

The current collector of the cathode 20 is electrically connected to one end of the cathode lead 22, for example, made of aluminum and the other end of the cathode lead 22 extends outward from the case 50. On the other hand, the current collector of the anode 10 is also electrically connected to one end of the anode lead 12, for example, made of copper or nickel, and the other end of the anode lead 12 extends outward from the case 50.

There are no particular restrictions on the separator 40 disposed between the anode 10 and the cathode 20, as long as it is made of a porous material having ion permeability and electrical insulation. The separator 40 can be one of the separators used in the well-known electrochemical devices. Examples of such separators 40 include film laminates of polyethylene, polypropylene, or polyolefin, stretched films of mixtures of the foregoing polymers, nonwoven fabric of fiber consisting of at least one constituent material selected from the group consisting of cellulose, polyester, and polypropylene, and so on.

The electrolyte solution (not shown) is filled in the interior space of the case 50 and part thereof is contained in the interior of the anode 10, cathode 20, and separator 40. The electrolyte solution used herein is a nonaqueous electrolyte solution in which a lithium salt is dissolved in an organic solvent. The lithium salt used herein is, for example, one of salts such as LiPF₆, LiClO₄, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), and LiN(CF₃CF₂CO)₂. These salts may be used singly or in combination of two or more. The electrolyte solution may be used in a gel form with an additive of a polymer or the like.

The organic solvent used herein can be one of solvents used in the well-known electrochemical devices. Examples of solvents preferably applicable include propylene carbonate, ethylene carbonate, and diethylcarbonate. These may be used singly or as a mixture of two or more at any ratio.

The case 50 is made of a pair of films (first film 51 and second film 52) opposed to each other. It is noted herein that the first film 51 and the second film 52 in the present embodiment are coupled to each other, as shown in FIG. 5. Specifically, the case 50 in the present embodiment is made by folding a rectangular film consisting of a sheet of composite packaging film, on a fold line X3-X3 in FIG. 5, superimposing a set of opposed edges of the rectangular film (edge 51B of the first film 51 and edge 52B of the second film 52 in the drawing) on each other, and bonding them to each other with an adhesive or by heat sealing. Partial region 51A in FIGS. 4 and 5 and partial region 52A in FIG. 5 indicate regions that are not bonded with an adhesive or by heat sealing in the first film 51 and the second film 52, respectively.

The first film 51 and the second film 52 indicate respective portions of a sheet of rectangular film having mutually facing surfaces made by folding the film as described above. In the present specification, the respective edges of the first film 51 and the second film 52 after bonded will be referred to as “sealed portions.”

This eliminates a need for providing the region along the fold line X3-X3 with a sealed portion for joining between the first film 51 and the second film 52, and thus reduces the number of sealed portions in the case 50. As a result, it further increases the volume energy density based on the volume of the space in which the electrochemical device 1 is to be installed.

In the present embodiment, as shown in FIGS. 4 and 5, one end of the anode lead 12 connected to the anode 10 and one end of the cathode lead 22 connected to the cathode 20 are arranged so as to project outward from the sealed portion in which the aforementioned edge 51B of the first film 51 and edge 52B of the second film 52 are joined together.

The film forming the first film 51 and the second film 52 is a flexible film. Since the film is lightweight and easy to be thinned, the electrochemical device itself can be formed in a low profile. For this reason, it is easy to increase the original volume energy density and also to increase the volume energy density based on the volume of the space in which the electrochemical device is to be installed.

There are no particular restrictions on this film as long as it is a flexible film. The film is preferably a “composite packaging film” having at least an innermost layer of a polymer in contact with a power-generating element 60, and a metal layer located on the side opposite to the side where the innermost layer is in contact with the power-generating element, from the viewpoints of ensuring sufficient mechanical strength and lightweight property of the case and effectively preventing intrusion of water and air from the outside of the case 50 into the inside of the case 50 and escape of the electrolyte component from the inside of the case 50 to the outside of the case 50.

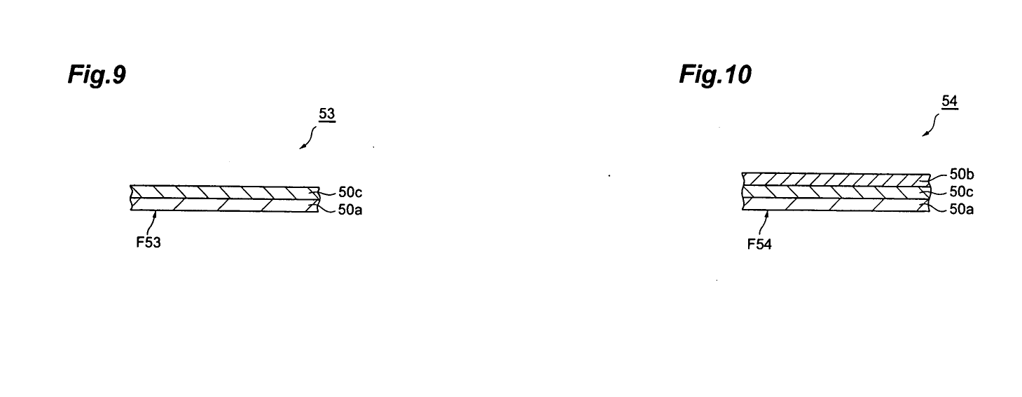

The composite packaging film applicable as the first film 51 and second film 52 can be, for example, a composite packaging film in one of structures shown in FIG. 9 and FIG. 10. The composite packaging film 53 shown in FIG. 9 has an innermost layer 50a of a polymer with an inner surface F53 in contact with the power-generating element 60, and a metal layer 50c disposed on the other surface (outer surface) of the innermost layer 50a. The composite packaging film 54 shown in FIG. 10 has a structure in which an outermost layer 50b of a polymer is further disposed on the outer surface of the metal layer 50c in the composite packaging film 53 shown in FIG. 9.

There are no particular restrictions on the composite packaging film applicable as the first film 51 and second film 52 as long as it is a composite packaging material having two or more layers including at least one polymer layer, e g., the innermost layer, and the metal layer of metal foil or the like. From the viewpoint of achieving the same effect as above more definitely, the composite packaging film is more preferably composed of three or more layers including the innermost layer 50a, the outermost layer 50b of a polymer disposed on the outer surface side of the case 50 farthest from the innermost layer 50a, and at least one metal layer 50c disposed between the innermost layer 50a and the outermost layer 50b as in the composite packaging film 54 shown in FIG. 10.

The innermost layer 50a is a layer with flexibility and there are no particular restrictions on a constituent material thereof as long as it is a polymer that can exhibit the aforementioned flexibility and that has chemical stability (resistance to chemical reaction, dissolution, and swelling) to the nonaqueous electrolyte solution used and chemical stability to oxygen and water (water in air). However, the constituent material is preferably a material with low permeability for oxygen, water (water in air), and the components of the nonaqueous electrolyte solution. The material can be selected, for example, from engineering plastics and thermoplastic resins such as polyethylene, polypropylene, acid-modified polyethylene, acid-modified polypropylene, polyethylene ionomer, and polypropylene ionomer.

The “engineering plastics” means plastics with excellent mechanical characteristics, thermal resistance, and endurance as used in mechanical components, electrical components, residential materials, etc., and examples thereof include polyacetal, polyamide, polycarbonate, poly(oxytetramethylene-oxyterephthaloyl) (polybutylene terephthalate), polyethylene terephthalate, polyimide, and polyphenylene sulfide.

When a polymer layer like the outermost layer 50b is further provided in addition to the innermost layer 50a as in the composite packaging film 54 shown in FIG. 10, this polymer layer may be made using a constituent material similar to the innermost layer 50a.

The metal layer 50c is preferably a layer made of a metal material with corrosion resistance to oxygen, water (water in air), and the nonaqueous electrolyte solution. For example, the metal layer 50c may be made of a metal foil of aluminum, an aluminum alloy, titanium, or chromium.

There are no particular restrictions on how to seal all the sealed portions in the case 50, but the heat sealing method is preferably applicable in terms of productivity.

As shown in FIGS. 4 and 5, the portion of the anode lead 12 in contact with the sealed portion of the exterior bag consisting of the edge 51B of the first film 51 and the edge 52B of the second film 52 is covered by an insulator 14 for preventing contact between the anode lead 12 and the metal layer in the composite packaging film forming each film. Furthermore, the portion of the cathode lead 22 in contact with the sealed portion of the exterior bag consisting of the edge 51B of the first film 51 and the edge 52B of the second film 52 is covered by an insulator 24 for preventing contact between the cathode lead 22 and the metal layer in the composite packaging film forming each film.

There are no particular restrictions on configurations of these insulators 14 and 24, but each of them may be made, for example, of a polymer. It is also possible to adopt a configuration without these insulators 14 and 24 if the contact of the metal layer in the composite packaging film is adequately prevented to each of the anode lead 12 and the cathode lead 22.

Next, the aforementioned electrochemical device 1 can be produced, for example, according to the following procedure. First, the anode lead 12 and the cathode lead 22 are electrically connected to the anode 10 and to the cathode 20, respectively. Thereafter, the separator 40 is placed in contact between the anode 10 and the cathode 20 (preferably, in a non-bonded state), thereby completing the power-generating element 60.

Then the case 50 is produced, for example, according to the following method. First, where the first film and the second film are made of the aforementioned composite packaging film, the film is produced by one of the known methods such as dry lamination, wet lamination, hot melt lamination, and extrusion lamination. Prepared are a film for the polymer layer, and a metal foil of aluminum or the like, which constitute the composite packaging film. The metal foil can be prepared, for example, by rolling a metal material.

Next, the composite packaging film (multilayered film) is produced, preferably, in the aforementioned structure of plural layers, for example, by bonding the metal foil onto the film for the polymer layer with an adhesive. Then the composite packaging film is cut in predetermined size to prepare a sheet of rectangular film.

Next, as described above with reference to FIG. 5, the sheet of film is folded and the sealed portion 51B (edge 51B) of the first film 51 and the sealed portion 52B (edge 52B) of the second film 52 are, for example, heat-sealed in a desired seal width under a predetermined heat condition with a sealing machine. At this time, the film is left without being heat-sealed in part, in order to secure an aperture for introducing the power-generating element 60 into the case 50. This obtains the case 50 in a state with the aperture.

Then the power-generating element 60 with the anode lead 12 and the cathode lead 22 being electrically connected thereto is put into the interior of the case 50 with the aperture. Then the electrolyte solution is poured into the interior. Subsequently, the aperture of the case 50 is sealed with a sealing machine in a state in which the anode lead 12 and the cathode lead 22 each are inserted in part in the case 50. The case 50 and the electrochemical device 1 are completed in this manner. It should be noted that the electrochemical device of the present invention is not limited to this shape but may also be formed in any other shape such as a cylindrical shape.

The above detailed the preferred embodiment of the electrochemical device of the present invention, but the present invention is by no means intended to be limited to the above embodiment. For example, in the description of the above embodiment, the sealed portions of the electrochemical device 1 may be folded to achieve a more compact structure. The above embodiment described the electrochemical device 1 with one each of the anode 10 and cathode 20, but the electrochemical device may be constructed in a configuration wherein there are one or more of each of the anode 10 and cathode 20 and wherein a separator 40 is always located between the anode 10 and cathode 20.

For example, the above embodiment mainly described the case where the electrochemical device was the lithium-ion secondary battery, but the electrochemical device of the present invention is not limited to the lithium-ion secondary battery. The electrochemical device of the present invention may be any other secondary battery than the lithium-ion secondary battery, e.g., a metal lithium secondary battery (in which the cathode is the electrode of the present invention and the anode is metal lithium), or an electrochemical capacitor such as an electric double-layer capacitor, a pseudo-capacitance capacitor, a pseudo-capacitor, or a redox capacitor. The electrochemical device of the present invention is also applicable to use as a power supply in a self-propelled micromachine or an IC card, and a dispersed power supply located on or in a printed circuit board. In the case of the electrochemical devices other than the lithium-ion secondary battery, the active material particle may be one suitable for each electrochemical device.

### EXAMPLES

The present invention will be described more specifically below based on examples and comparative examples, but it is noted that the present invention is by no means limited to the examples below.

### Example 1

LiFePO₄ with the average particle size of 3 μm as the active material body and acetylene black with the average primary particle size of 80 nm as the conductive aid were dry-processed at a mixture ratio of 90:10 by mass for one hour with a ball mill and further thermally processed at 500° C. in an Ar atmosphere for one hour to obtain active material particles in which the conductive aid was deposited on the active material body.

<SEM Photograph Observation>

An SEM photograph of the active material particles obtained was taken at the magnification of ×30000 at each of ten random portions, and a grid pattern of 1 μm×1 μm was drawn on each photograph at one portion (one photograph). In each of the 1 μm×1 μm fields, the coverage of the conductive aid over the active material and the percentage of the continuous layer were determined and an average among all the fields was calculated. The presence/absence of projection on the surface of the covering part consisting of the conductive aid was checked in the foregoing SEM photographs at the ten random portions. The number of projections was measured by observation of the SEM photographs at the ten portions and when the number of projections per photograph at one portion on average was 1 or more, it was determined that the projection was present, whereas when the number of projections per photograph at one portion on average was less than 1, it was determined that the projection was absent. The result is presented in Table 1 below.

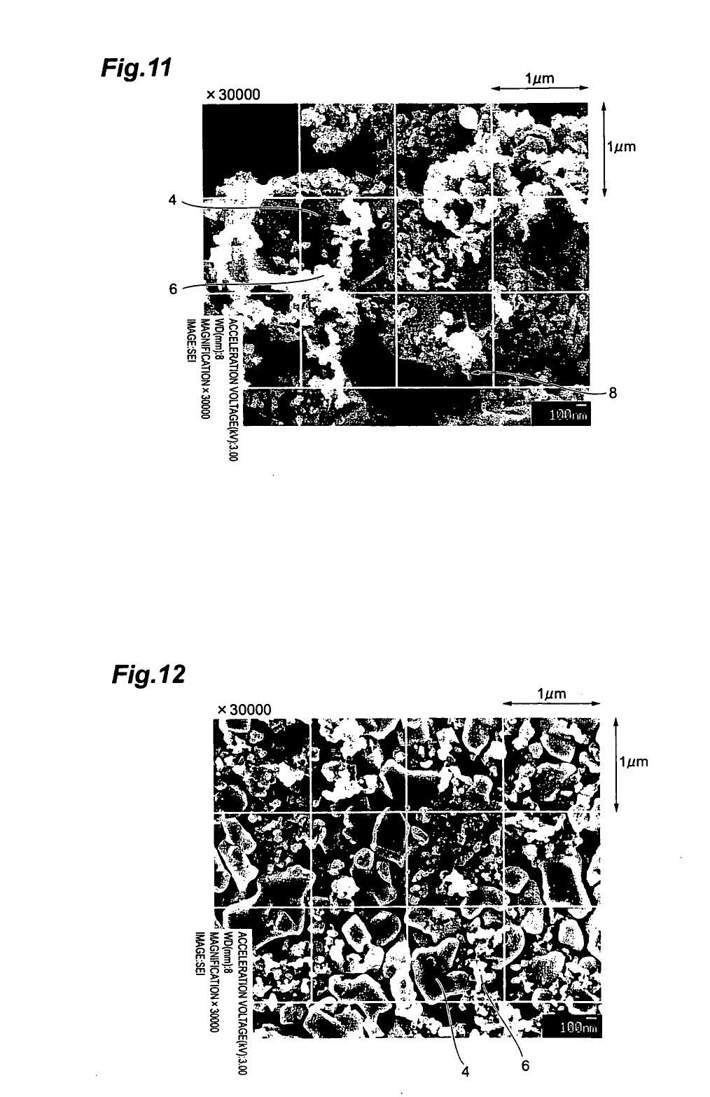

One of the SEM photographs of the active material particles in Example 1 is shown in FIG. 11. It is confirmed in FIG. 11 that the conductive aid 6 partially covers the surface of the active material body 4. Furthermore, it is also confirmed that the projection 8 is formed on the surface of the covering part of the conductive aid 6. On the other hand, FIG. 12 shows an SEM photograph of the active material body and the conductive aid in a conventional electrode formed by applying a slurry containing a mixture of the active material body, the conductive aid, a binder, and a solvent, onto a current collector. It is confirmed in FIG. 12 that, when compared with the active material particles shown in FIG. 11, the conductive aid 6 rarely covers the surface of the active material body 4 and that no projection is formed.

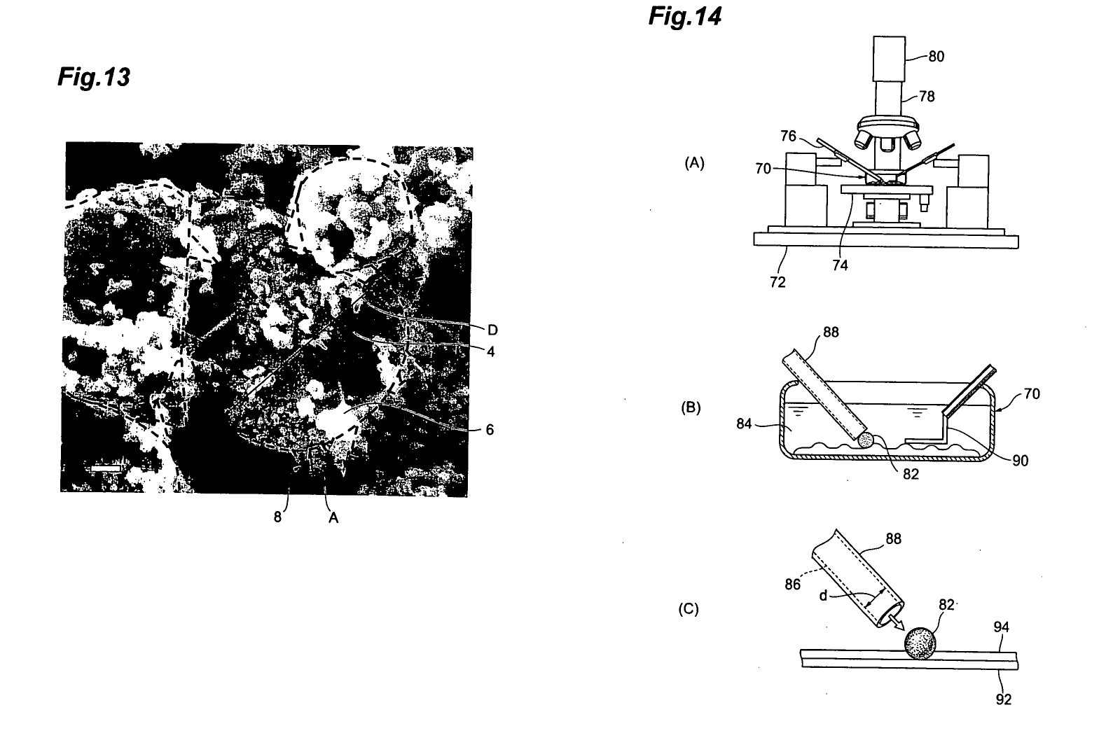

FIG. 13 is an enlarged photograph of a part of the SEM photograph of the active material particles shown in FIG. 11. As shown in this SEM photograph, the maximum Rₘₐₓ (%) was determined for the ratio of the height A of the projection 8 to the particle size D of the active material body 4. In the SEM photographs at the ten random portions, the maximum was determined for the ratio (A/B) of the height A of the projection 8 to the length B of the side (base) where the entire covering part was in contact with the active material body 4. The results are presented in Table 1 below.

<Measurement of Constant-Potential Charge-Discharge Performance of Active Material Particle>

FIG. 14 shows a schematic view of a microelectrode measuring system used in the present measurement. FIG. 14(A) is an overall image of the system, FIG. 14(B) is an enlarged view of a cell, and FIG. 14(C) is an enlarged view of a contact part between an active material particle and a microelectrode.

As shown in FIG. 14, a microscope system with a cell 70 thereon was placed on a vibration-free table 72 and set in a glove box (main box) filled with dry argon gas (the dew point of which was −80° C. or below). The cell 70 was of stainless steel and was set on an observation stand 74 of the microscope. The active material particles 82 obtained above were sprinkled from top over a PET film 92 with a PVDF slurry applied thereon, and dried, whereby the active material particles 82 were fixed on the PET film 92 by a PVDF layer 94. The film was cut into a piece in a predetermined area, the piece was set on the bottom of the stainless steel cell 70, and LiPF₆/PC was poured as an electrolyte solution 84 into the cell.

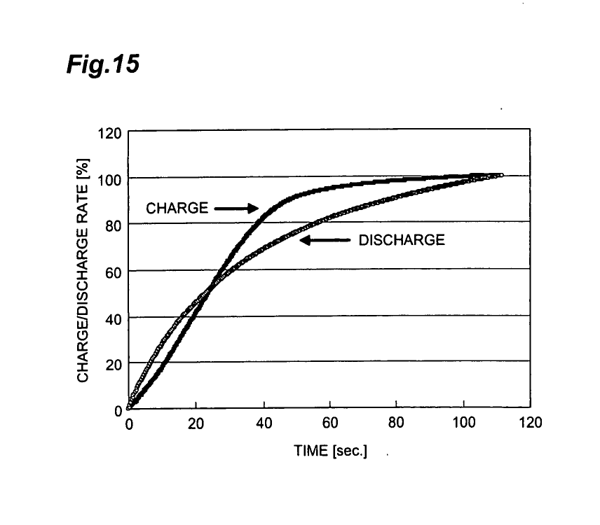

While observing an image of CCD camera 80 mounted on the microscope 78, a micro manipulator 76 was manipulated to bring the tip of a microelectrode 88 (diameter d=10 μm), which was fabricated by enclosing a metal wire 86 with glass and polishing the tip thereof into contact with an active material particle 82 to establish electric contact. Then 4.5V constant-potential charging and 2.5V constant-potential discharging measurements were conducted on the basis of lithium of reference electrode 90. The result thereof is shown in FIG. 15. FIG. 15 is a graph showing the relationship between charge/discharge rate and time during the constant-potential charging/discharging. Times to 80% charge and 80% discharge were determined from the measurements and the rapid charge-discharge performance of active material particles was compared. At this time, the reversible capacity obtained with a cyclic voltammetry of 0.2 mV/s was defined as 100% capacity of the active material particle. The result is presented in Table 1.

<Evaluation of Electrode Characteristic>

The active material particles (93 parts by mass) obtained above were mixed with carbon black (3 parts by mass) as a conductive aid and PVDF (4 parts by mass) as a binder and the mixture was dispersed in N-methyl-2-pyrrolidone) to prepare a slurry for formation of the active material-containing layer. This slurry was applied onto an aluminum foil being a current collector, and dried, and then the resultant was rolled to obtain an electrode in which the active material-containing layer 40 μm thick was formed on the current collector 20 μm thick. Then the resulting electrode and an Li foil (100 μm thick) as a counter electrode were laminated with a separator of polyethylene in between them to obtain a laminate (element body). This laminate was put into an Al laminate package, 1M LiPF₆/PC as an electrolyte solution was poured into this Al laminate package, and thereafter this Al laminate package was sealed in vacuum to fabricate an electrode evaluation cell (48 mm long, 34 mm wide, and 2 mm thick). This cell was subjected to a charge-discharge test to evaluate the rate performance and the rapid charge-discharge performance of the electrode was compared. This evaluation of electrode performance (rapid discharge performance) was carried out in the following manner: the cell was fully charged at a cutoff voltage by 1C constant-current constant-voltage charge, it was discharged at 1C to a discharge cutoff voltage, it was then fully charged again, thereafter it was discharged at 5C to the discharge cutoff voltage, and a ratio of capacity in the 5C discharge to capacity in the 1C discharge {(capacity in 5C discharge/capacity in 1C discharge)×100} was calculated. An amount of electric current for discharging (or charging) the entire capacity of the battery determined from the amount of the electrode active material, in one hour is defined as a 1C rate, and multiples of the amount of electric current are expressed by C rates. When LiFePO₄ was used as the active material body as in the present example, the cutoff voltage was 4.5 V on the charging side and the cutoff voltage was 2.5 V on the discharging side. On the other hand, when Li₄Ti₅O₁₂ was used as the active material body as described below, the cutoff voltage was 0.8 V on the charging side and 2.2 V on the discharging side. The result is presented in Table 1.

### Example 2

LiFePO₄ with the average particle size of 3 μm as the active material body was subjected to chemical vapor deposition of carbon using toluene as a chemical species, in a fluid bed reactor, under the condition that the mass ratio of LiFePO₄ and carbon was adjusted at 90:10, thereby obtaining the active material particles in which the conductive aid (carbon) was deposited on the active material body.

With the active material particles obtained, the SEM photograph observation, the measurement of constant-potential charge-discharge performance of the active material particle, and the characteristic evaluation of an electrode fabricated with the active material particles were carried out in the same manner as in Example 1. The results are presented in Table 1.

### Example 3

FeSO₄.7H₂O, H₃PO₄, and LiOH were dissolved in pure water and the mixture was subjected to 4-hour hydrothermal synthesis at 150° C. to obtain LiFePO₄ with the average particle size of 0.5 μM as the active material body. This LiFePO₄ was mixed with a sucrose solution as a carbon precursor so that the mass ratio of LiFePO₄ and carbon became 90:10, and the mixture was thermally treated at 800° C. in an Ar atmosphere for one hour to obtain active material particles in which the conductive aid (carbon) was deposited on the active material body.

With the active material particles obtained, the SEM photograph observation, the measurement of constant-potential charge-discharge performance of the active material particle, and the characteristic evaluation of an electrode fabricated with the active material particles were carried out in the same manner as in Example 1. The results are presented in Table 1.

### Example 4

Li₄Ti₅O₁₂ with the average particle size of 3 μm as the active material body and acetylene black with the average primary particle size of 80 μm as the conductive aid were dry-processed at the mixture ratio of 90:10 by mass with a ball mill for one hour and the mixture was further thermally treated at 500° C. in an Ar atmosphere for one hour to obtain active material particles in which the conductive aid was deposited on the active material body.

With the active material particles obtained, the SEM photograph observation was conducted in the same manner as in Example 1. The measurement of constant-potential charge-discharge performance of the active material particle and the characteristic evaluation of an electrode fabricated with the active material particles were also carried out in the same manner as in Example 1, except that the charge potential was 2.2 V and the discharge potential was 0.8 V. The results are presented in Table 1.

### Comparative Example 1

LiFePO₄ with the average particle size of 3 μm as the active material body and acetylene black with the average primary particle size of 80 nm as the conductive aid were dry-processed at the mixture ratio of 90:10 by mass with a ball mill for five minutes and the mixture was further thermally treated at 500° C. in an Ar atmosphere for one hour to obtain active material particles in which the conductive aid was deposited on the active material body.

With the active material particles obtained, the SEM photograph observation, the measurement of constant-potential charge-discharge performance of the active material particle, and the characteristic evaluation of an electrode fabricated with the active material particles were carried out in the same manner as in Example 1. The results are presented in Table 1.

### Comparative Example 2

LiFePO₄ with the average particle size of 3 μm as the active material body was subjected to chemical vapor deposition of carbon using toluene as a chemical species, in a fluid bed reactor, under the condition that the mass ratio of LiFePO₄ and carbon was adjusted to 99.5:0.5, to obtain active material particles in which the conductive aid (carbon) was deposited on the active material body.

With the active material particles obtained, the SEM photograph observation, the measurement of constant-potential charge-discharge performance of the active material particle, and the characteristic evaluation of an electrode fabricated with the active material particles were carried out in the same manner as in Example 1. The results are presented in Table 1.

### Comparative Example 3

LiFePO₄ with the average particle size of 3 μm as the active material body and graphite with the average particle size of 3 μm as the conductive aid were dry-processed at the mixture ratio of 90:10 by mass with a ball mill for one hour and the mixture was further thermally treated at 500° C. in an Ar atmosphere for one hour to obtain active material particles in which the conductive aid was deposited on the active material body.

With the active material particles obtained, the SEM photograph observation, the measurement of constant-potential charge-discharge performance of the active material particle, and the characteristic evaluation of an electrode fabricated with the active material particles were carried out in the same manner as in Example 1. The results are presented in Table 1.

TABLE 1

| | | | | | | | Constant-P C-D | | Electrode |
|---|---|---|---|---|---|---|---|---|---|
| | | | | | | | perf. | | chara. |
| | AM:CA | SEM photograph observation | | | | | 80% C | 80% D | rate perf. |
| | ratio | CVRG | | | Rₘₐₓ | | time | time | (5C/1C) |
| | (mass) | (%) | CL (%) | PRJN | (%) | A/B | (sec) | (sec) | (%) |
| Ex 1 | 90:10 | 45 | 22.5 | present | 18 | 0.67 | 38 | 57 | 98 |
| Ex 2 | 90:10 | 64 | 51.2 | present | 7 | 0.17 | 23 | 39 | 100 |
| Ex 3 | 90:10 | 58 | 40.6 | present | 27 | 1.8 | 28 | 48 | 100 |
| Ex 4 | 90:10 | 41 | 12.3 | present | 13 | 1.3 | 18 | 58 | 97 |
| C. Ex 1 | 90:10 | 13 | 1.3 | absent | — | — | 145 | 218 | 43 |
| C. Ex 2 | 99.5:0.5 | 4 | 0.2 | absent | — | — | 900 | 1770 | 9 |
| C. Ex 3 | 90:10 | 17 | 2.6 | absent | — | — | 112 | 180 | 56 |

(Note)
Ex: Example;
C. Ex: Comparative Example
AM:CA: active material:conductive aid;
CVRG: coverage; CL: continuous layer;
PRJN: projection;
Constant-P: constant-potential;
C-D: charge-discharge;
C time: charge time;
D time: discharge time;
perf.: performance;
chara.: characteristic.

### Example 5

LiFePO₄ with the average particle size of 3 μm as the active material body and acetylene black with the average primary particle size of 80 nm as the conductive aid were dry-processed at the mixture ratio of 90:10 by mass with a ball mill for 59 minutes and the mixture was further thermally treated at 500° C. in an Ar atmosphere for 48 minutes to obtain active material particles in which the conductive aid was deposited on the active material body.

### Example 6

LiFePO₄ with the average particle size of 3 μm as the active material body and acetylene black with the average primary particle size of 80 nm as the conductive aid were dry-processed at the mixture ratio of 90:10 by mass with a ball mill for 47 minutes and the mixture was further thermally treated at 500° C. in an Ar atmosphere for 40 minutes to obtain active material particles in which the conductive aid was deposited on the active material body.

### Example 7

LiFePO₄ with the average particle size of 3 μm as the active material body and acetylene black with the average primary particle size of 80 nm as the conductive aid were dry-processed at the mixture ratio of 90:10 by mass with a ball mill for 52 minutes and the mixture was further thermally treated at 500° C. in an Ar atmosphere for 35 minutes to obtain active material particles in which the conductive aid was deposited on the active material body.

### Example 8

LiFePO₄ with the average particle size of 3 μm as the active material body and acetylene black with the average primary particle size of 150 nm as the conductive aid were dry-processed at the mixture ratio of 90:10 by mass with a ball mill for 45 minutes and the mixture was further thermally treated at 500° C. in an Ar atmosphere for two hours to obtain active material particles in which the conductive aid was deposited on the active material body.

### Example 9

LiFePO₄ with the average particle size of 3 μm as the active material body and acetylene black with the average primary particle size of 150 nm as the conductive aid were dry-processed at the mixture ratio of 90:10 by mass with a ball mill for 55 minutes and the mixture was further thermally treated at 500° C. in an Ar atmosphere for one hour to obtain active material particles in which the conductive aid was deposited on the active material body.

### Example 10

LiFePO₄ with the average particle size of 3 μm as the active material body and acetylene black with the average primary particle size of 80 nm as the conductive aid were dry-processed at the mixture ratio of 90:10 by mass with a ball mill for 46 minutes and the mixture was further thermally treated at 500° C. in an Ar atmosphere for 70 minutes to obtain active material particles in which the conductive aid was deposited on the active material body.

### Example 11

LiFePO₄ with the average particle size of 3 μm as the active material body and acetylene black with the average primary particle size of 80 nm as the conductive aid were dry-processed at the mixture ratio of 90:10 by mass with a ball mill for 55 minutes and the mixture was further thermally treated at 500° C. in an Ar atmosphere for 57 minutes to obtain active material particles in which the conductive aid was deposited on the active material body.

### Example 12

LiFePO₄ with the average particle size of 3 μm as the active material body and acetylene black with the average primary particle size of 80 nm as the conductive aid were dry-processed at the mixture ratio of 90:10 by mass with a ball mill for 55 minutes and the mixture was further thermally treated at 500° C. in an Ar atmosphere for 45 minutes to obtain active material particles in which the conductive aid was deposited on the active material body.

### Example 13

LiFePO₄ with the average particle size of 3 μm as the active material body and acetylene black with the average primary particle size of 80 nm as the conductive aid were dry-processed at the mixture ratio of 90:10 by mass with a ball mill for 65 minutes and the mixture was further thermally treated at 400° C. in an Ar atmosphere for one hour to obtain active material particles in which the conductive aid was deposited on the active material body.

### Example 14

LiFePO₄ with the average particle size of 3 μm as the active material body and acetylene black with the average primary particle size of 80 nm as the conductive aid were dry-processed at the mixture ratio of 90:10 by mass with a ball mill for 72 minutes and the mixture was further thermally treated at 400° C. in an Ar atmosphere for 50 minutes to obtain active material particles in which the conductive aid was deposited on the active material body.

### Example 15

LiFePO₄ with the average particle size of 3 μm as the active material body and acetylene black with the average primary particle size of 80 nm as the conductive aid were dry-processed at the mixture ratio of 90:10 by mass with a ball mill for 79 minutes and the mixture was further thermally treated at 400° C. in an Ar atmosphere for 40 minutes to obtain active material particles in which the conductive aid was deposited on the active material body.

### Example 16

LiFePO₄ with the average particle size of 3 μm as the active material body and acetylene black with the average primary particle size of 50 nm as the conductive aid were dry-processed at the mixture ratio of 90:10 by mass with a ball mill for 45 minutes and the mixture was further thermally treated at 500° C. in an Ar atmosphere for 50 minutes to obtain active material particles in which the conductive aid was deposited on the active material body.

### Example 17

LiFePO₄ with the average particle size of 3 μm as the active material body and acetylene black with the average primary particle size of 50 nm as the conductive aid were dry-processed at the mixture ratio of 90:10 by mass with a ball mill for 82 minutes and the mixture was further thermally treated at 500° C. in an Ar atmosphere for one hour to obtain active material particles in which the conductive aid was deposited on the active material body.

### Example 18

LiFePO₄ with the average particle size of 3 μm as the active material body and acetylene black with the average primary particle size of 80 nm as the conductive aid were dry-processed at the mixture ratio of 90:10 by mass with a ball mill for 39 minutes and the mixture was further thermally treated at 500° C. in an Ar atmosphere for one hour to obtain active material particles in which the conductive aid was deposited on the active material body.

### Example 19

LiFePO₄ with the average particle size of 3 μm as the active material body and acetylene black with the average primary particle size of 80 nm as the conductive aid were dry-processed at the mixture ratio of 90:10 by mass with a ball mill for 90 minutes and the mixture was further thermally treated at 500° C. in an Ar atmosphere for 40 minutes to obtain active material particles in which the conductive aid was deposited on the active material body.

### Example 20

LiFePO₄ with the average particle size of 3 μm as the active material body and acetylene black with the average primary particle size of 80 nm as the conductive aid were dry-processed at the mixture ratio of 90:10 by mass with a ball mill for 94 minutes and the mixture was further thermally treated at 500° C. in an Ar atmosphere for 30 minutes to obtain active material particles in which the conductive aid was deposited on the active material body.

### Example 21

LiFePO₄ with the average particle size of 3 μm as the active material body and acetylene black with the average primary particle size of 80 nm as the conductive aid were dry-processed at the mixture ratio of 90:10 by mass with a ball mill for 100 minutes and the mixture was further thermally treated at 500° C. in an Ar atmosphere for 20 minutes to obtain active material particles in which the conductive aid was deposited on the active material body.

### Example 22

LiFePO₄ with the average particle size of 3 μm as the active material body and acetylene black with the average primary particle size of 80 nm as the conductive aid were dry-processed at the mixture ratio of 90:10 by mass with a ball mill for 55 minutes and the mixture was further thermally treated at 500° C. in an Ar atmosphere for 48 minutes to obtain active material particles in which the conductive aid was deposited on the active material body.

### Example 23

LiFePO₄ with the average particle size of 3 μm as the active material body and acetylene black with the average primary particle size of 80 nm as the conductive aid were dry-processed at the mixture ratio of 90:10 by mass with a ball mill for 75 minutes and the mixture was further thermally treated at 500° C. in an Ar atmosphere for one hour to obtain active material particles in which the conductive aid was deposited on the active material body.

### Example 24

LiFePO₄ with the average particle size of 3 μm as the active material body and acetylene black with the average primary particle size of 80 nm as the conductive aid were dry-processed at the mixture ratio of 87.5:12.5 by mass with a ball mill for 80 minutes and the mixture was further thermally treated at 500° C. in an Ar atmosphere for 50 minutes to obtain active material particles in which the conductive aid was deposited on the active material body.

### Example 25

LiFePO₄ with the average particle size of 3 μm as the active material body and acetylene black with the average primary particle size of 80 nm as the conductive aid were dry-processed at the mixture ratio of 85:15 by mass with a ball mill for 80 minutes and the mixture was further thermally treated at 500° C. in an Ar atmosphere for 40 minutes to obtain active material particles in which the conductive aid was deposited on the active material body.

### Comparative Example 4

LiFePO₄ with the average particle size of 3 μm as the active material body and acetylene black with the average primary particle size of 50 nm as the conductive aid were dry-processed at the mixture ratio of 90:10 by mass with a ball mill for 55 minutes and the mixture was further thermally treated at 500° C. in an Ar atmosphere for 48 minutes to obtain active material particles in which the conductive aid was deposited on the active material body.

### Comparative Example 5

LiFePO₄ with the average particle size of 3 μm as the active material body and acetylene black with the average primary particle size of 80 nm as the conductive aid were dry-processed at the mixture ratio of 82.5:17.5 by mass with a ball mill for 105 minutes and the mixture was further thermally treated at 650° C. in an Ar atmosphere for 80 minutes to obtain active material particles in which the conductive aid was deposited on the active material body.

### Comparative Example 6

LiFePO₄ with the average particle size of 3 μm as the active material body and acetylene black with the average primary particle size of 80 nm as the conductive aid were dry-processed at the mixture ratio of 80:20 by mass with a ball mill for 105 minutes and the mixture was further thermally treated at 500° C. in an Ar atmosphere for 80 minutes to obtain active material particles in which the conductive aid was deposited on the active material body.

<SEM Photograph Observation and Characteristic Evaluation>

With the active material particles obtained in Examples 5-25 and Comparative Examples 4-6, the SEM photograph observation, the measurement of constant-potential charge-discharge performance of the active material particle, and the characteristic evaluation of an electrode fabricated with the active material particles were carried out in the same manner as in Example 1. The results are presented in Table 2 below.

TABLE 2

| | | | | | | | Constant-P C-D | | Electrode |
|---|---|---|---|---|---|---|---|---|---|
| | | | | | | | perf. | | chara. |
| | AM:CA | SEM photograph observation | | | | | 80% C | 80% D | rate perf. |
| | ratio | | | | Rₘₐₓ | | time | time | (5C/1C) |
| | (mass) | CVRG (%) | CL (%) | PRJN | (%) | A/B | (sec) | (sec) | (%) |
| Ex 5 | 90:10 | 55 | 18.3 | present | 5 | 0.7 | 43 | 65 | 95 |
| Ex 6 | 90:10 | 48 | 33.5 | present | 5 | 0.5 | 41 | 63 | 96 |
| Ex 7 | 90:10 | 41 | 30.8 | present | 7 | 0.7 | 46 | 66 | 95 |
| Ex 8 | 90:10 | 22 | 8 | present | 12 | 6 | 63 | 94 | 90 |
| Ex 9 | 90:10 | 25 | 10 | present | 12 | 3 | 31 | 68 | 95 |
| Ex 10 | 90:10 | 37 | 12 | present | 12 | 1.7 | 28 | 61 | 96 |
| Ex 11 | 90:10 | 44 | 15 | present | 12 | 1.3 | 19 | 53 | 99 |
| Ex 12 | 90:10 | 46 | 18 | present | 12 | 1 | 15 | 41 | 100 |
| Ex 13 | 90:10 | 52 | 20 | present | 12 | 0.8 | 9 | 19 | 100 |
| Ex 14 | 90:10 | 63 | 33 | present | 12 | 0.6 | 8 | 17 | 100 |
| Ex 15 | 90:10 | 68 | 45 | present | 12 | 0.5 | 9 | 20 | 100 |
| Ex 16 | 90:10 | 37 | 47 | present | 12 | 1.5 | 13 | 46 | 100 |
| Ex 17 | 90:10 | 72 | 50 | present | 12 | 0.15 | 14 | 49 | 98 |
| Ex 18 | 90:10 | 29 | 53 | present | 12 | 1.2 | 43 | 65 | 96 |
| Ex 19 | 90:10 | 81 | 70 | present | 12 | 0.3 | 47 | 74 | 95 |
| Ex 20 | 90:10 | 84 | 80 | present | 12 | 0.12 | 53 | 81 | 93 |
| Ex 21 | 90:10 | 89 | 83 | present | 12 | 0.05 | 61 | 95 | 90 |
| Ex 22 | 90:10 | 41 | 18 | present | 18 | 0.6 | 45 | 72 | 95 |
| Ex 23 | 90:10 | 57 | 47.5 | present | 18 | 0.9 | 43 | 68 | 96 |
| Ex 24 | 87.5:12.5 | 74 | 33 | present | 30 | 0.85 | 32 | 52 | 100 |
| Ex 25 | 85:15 | 67 | 45 | present | 30 | 0.45 | 26 | 44 | 100 |
| C. Ex 4 | 90:10 | 42 | 15.5 | present | 3.5 | 1.75 | 69 | 122 | 81 |
| C. Ex 5 | 82.5:17.5 | 91 | 33 | present | 33 | 0.14 | 78 | 131 | 78 |
| C. Ex 6 | 80:20 | 92 | 45 | present | 33 | 0.11 | 83 | 145 | 67 |

(Note)
Ex: Example;
C. Ex: Comparative Example;
AM:CA: active material:conductive aid;
CVRG: coverage;
CL: continuous layer;
PRJN: projection;
Constant-P: constant-potential;
C-D: charge-discharge;
C time: charge time;
D time: discharge time;
perf.: performance;
chara.: characteristic.

What is claimed is:

1. An active material particle for electrode comprising an active material body, and a conductive aid with electron conductivity partially covering a surface of the active material body,
wherein a projection comprised of the conductive aid is formed on the surface of the active material body, and
wherein a height of the projection from the surface of the active material body is not less than 5% nor more than 30% of a particle size of the active material body.

2. The active material particle for electrode according to claim 1, wherein the conductive aid directly covers the active material body.

3. The active material particle for electrode according to claim 1, wherein the projection has a region with a porosity larger on the tip side than on the active material body side.

4. The active material particle for electrode according to claim 1, wherein a continuous layer comprised of the conductive aid covers not less than 10% nor more than 80% of the surface of the active material body.

5. The active material particle for electrode according to claim 1, wherein not less than 5% nor more than 60% of the surface of the active material body is exposed without being covered by the conductive aid, and is continuous.

6. An electrode comprising as a constituent material an active material particle for electrode comprising an active material body, and a conductive aid with electron conductivity partially covering a surface of the active material body, wherein a projection comprised of the conductive aid is formed on the surface of the active material body, and wherein a height of the projection from the surface of the active material body is not less than 5% nor more than 30% of a particle size of the active material body.

7. An electrochemical device comprising an anode, a cathode, and an electrolyte layer with ion conductivity, and having a structure in which the anode and the cathode are opposed to each other through the electrolyte layer,
wherein at least one of the anode and the cathode is an electrode comprising as a constituent material an active material particle for electrode comprising an active material body, and a conductive aid with electron conductivity partially covering a surface of the active material body, wherein a projection comprised of the conductive aid is formed on the surface of the active material body, and wherein a height of the projection from the surface of the active material body is not less than 5% nor more than 30% of a particle size of the active material body.

8. A method of producing an electrode, comprising a step of mixing a binder and a conductive aid with an active material particle for electrode comprising an active material body, and a conductive aid with electron conductivity partially covering a surface of the active material body, wherein a projection comprised of the conductive aid is formed on the surface of the active material body, and wherein a height of the projection from the surface of the active material body is not less than 5% nor more than 30% of a particle size of the active material body.
